(19) United States
(12) Patent Application Publication
(10) Pub. No.: US 2026/0234917 A1
(43) Pub. Date: Aug. 13, 2026

(54) Device For Producing Temperature-Controlled Mixed Water

(71) Applicant: Grohe AG, Hemer (DE)

(72) Inventor: Jan Philipp Tueshaus, Hemer (DE)

(73) Assignee: Grohe AG, Hemer (DE)

(21) Appl. No.: 19/148,192

(22) PCT Filed: Feb. 26, 2024
(86) PCT No.: PCT/EP2024/054759

§ 371 Date: Jul. 15, 2025

(30) Foreign Application Priority Data
Mar. 3, 2023 (DE) 10 2023 105 313.2

(51) Int. Cl. E03C 1/05; F16K 11/20; F16K 31/40; G05D 23/13

(52) U.S. Cl. CPC E03C 1/055; F16K 11/20; F16K 31/404; G05D 23/1393

(57) ABSTRACT

The present invention relates to a device (1) for producing temperature-controlled mixed water, comprising a cold water duct (3) that is connectable to a cold water supply line (2), a hot water duct (5) that is connectable to a hot water supply line (4), a mixed water duct (6) into which the cold water duct (3) and the hot water duct (5) each open, a cold water diaphragm valve (8) arranged in the cold water duct (3) for limiting the cold water quantity flowing through the cold water duct (3), a hot water diaphragm valve (9) arranged in the hot water duct (5) for limiting the hot water quantity flowing through the hot water duct (5), a cold water actuator (10) for actuating the cold water diaphragm valve (8), a hot water actuator (12) for actuating the hot water diaphragm valve (9), and a pressure equalizing valve (14) arranged upstream of the cold water diaphragm valve (8) in the cold water duct (3) and upstream of the hot water diaphragm valve (9) in the hot water duct (5), wherein the pressure equalizing valve (14) is designed such that, in the event of a pressure difference between the cold water supply line (2) and the hot water supply line (4), said pressure equalizing valve automatically changes the flow cross-section of the cold water flowing through the pressure equalizing valve (14) and, at the same time, the flow cross-section of the hot water flowing through the pressure equalizing valve (14), such that the pressure difference is equalized downstream of the pressure equalizing valve (13).

The present invention relates to a device for producing temperature-controlled mixed water. Mixed water is the result of mixing cold water and hot water. Temperature-controlled mixed water is mixed water of a desired or set temperature, in particular a temperature desired or set by a user.

Devices of the type in question are well known from practice. Such devices comprise a connection for a cold water supply line and cold water duct connected thereto, as well as a connection for a hot water supply line and a hot water duct connected thereto. The cold water duct and the hot water duct can each be limited by a valve and each open into a mixed water duct which forms the outlet for temperature-controlled mixed water.

In order to make the production of temperature-controlled water convenient for the user, generic devices are also known which comprise actuators. The actuators are each associated with one of the valves and are each configured to control or actuate the associated valve in order to limit the corresponding duct. Such a device makes it possible to implement the mixed water temperature desired by a user by the actuators of the device suitably opening or closing the respectively associated valve.

However, a disadvantageous phenomenon of the known generic devices is that, in the event of a pressure difference between the connection for cold water or the cold water supply line and the connection for hot water or the hot water supply line, the actual mixed water temperature deviates from the desired mixed water temperature. In other words: In the event of such a pressure difference, the mixed water is colder or warmer than desired or set by the user. The reason for this is that if one of the two valves is subjected to a higher pressure than the other one of the two valves, a greater quantity of water flows through this valve than would be required to achieve the desired mixed water temperature. This has a direct effect on the mixing ratio of the mixed water and thus on its temperature.

Such a pressure difference can occur if, for example, by actuating the toilet flush, a relatively large cold water quantity is drawn within a relatively short time from the same supply line that feeds the cold water connection of the generic device. The withdrawal of cold water causes the pressure in the cold water supply line to drop briefly, so that the hot water quantity actually discharged into the mixed water duct as a result of this pressure difference exceeds the hot water quantity required to produce the desired mixed water temperature. If, as a result of the cold water withdrawal, the pressure in the hot water supply line exceeds the pressure in the cold water supply line by an extraordinary amount, this can lead to a dangerously high mixed water temperature, which can cause the user to be scalded.

Conversely, such a pressure difference can also occur if, for example, for the purpose of washing hands, a relatively large amount of hot water is drawn within a relatively short time from the same supply line that feeds the hot water connection of the generic device. As a result of this hot water withdrawal, the pressure in the hot water supply line drops briefly. Due to this pressure difference, the cold water quantity actually discharged into the mixed water duct exceeds the cold water quantity actually required to produce the desired mixed water temperature. This in turn can lead to a mixed water temperature that the user finds uncomfortably low.

To address the phenomenon described, it is conceivable to equip a generic device with pressure and/or temperature sensors in the cold water duct and in the hot water duct, to feed the information recorded in this manner to a control system and thus to achieve a more stable behavior of the generic device with regard to the production of temperature-controlled mixed water. However, this requires a great deal of effort in terms of design and circuitry and is therefore cost-intensive both in terms of manufacture and maintenance.

The underlying object of the present invention is therefore to at least partially solve the problem explained above as a whole and, in particular, to provide a device for producing temperature-controlled mixed water which can produce temperature-controlled mixed water independently of any pressure differences in the supply lines of the device, namely by using comparatively simple means.

The underlying object is achieved by a device for producing temperature-controlled mixed water with the features of claim 1. Advantageous further developments are each apparent from the subclaims.

A device for producing temperature-controlled mixed water is proposed, which comprises a cold water duct connectable to a cold water supply line, a hot water duct connectable to a hot water supply line and a mixed water duct into which the cold water duct and the hot water duct each open. The cold water duct and the hot water duct each comprise a connection for a corresponding supply line, which in each case forms the corresponding water inlet or inflow point of the device according to the invention. The mixed water duct forms the mixed water outlet or outflow point of the device according to the invention.

Furthermore, the device according to the invention comprises a cold water diaphragm valve arranged in the cold water duct for limiting the cold water quantity flowing through the cold water duct and a hot water diaphragm valve arranged in the hot water duct for limiting the hot water quantity flowing through the hot water duct. The cold water diaphragm valve thus also serves to limit the cold water quantity flowing into the mixed water duct. Analogously, the hot water diaphragm valve thus also serves to limit the hot water quantity flowing into the mixed water duct.

Furthermore, the device according to the invention comprises a cold water actuator for actuating, preferably in a continuously adjustable manner, that is, for opening and closing, the cold water diaphragm valve, and a hot water actuator for actuating, preferably in a continuously adjustable manner, that is, for opening and closing, the hot water diaphragm valve.

Finally, the device according to the invention comprises a pressure equalizing valve arranged upstream of the cold water diaphragm valve in the cold water duct, that is, upstream before the cold water diaphragm valve, and arranged upstream of the hot water diaphragm valve in the hot water duct, that is, upstream before the hot water diaphragm valve. There is only one pressure equalizing valve. The pressure equalizing valve is arranged both in the cold water duct and in the hot water duct which is separate from the cold water duct and, in particular, is not fluidically connected to the cold water duct.

The cold water duct of the device according to the invention comprises the entire cavity within the device according to the invention, from the connection for a cold water supply line, via the part of the pressure equalizing valve through which cold water flows, up to the cold water diaphragm valve. Analogously, the hot water duct of the device according to the invention comprises the entire cavity within the device according to the invention, from the connection for a hot water supply line, via the part of the pressure equalizing valve through which hot water flows, up to the hot water diaphragm valve.

According to the invention, the pressure equalizing valve is designed such that, in the event of a pressure difference between the cold water supply line and the hot water supply line, it automatically changes the flow cross-section of the cold water flowing through the pressure equalizing valve and, at the same time, changes the flow cross-section of the hot water flowing through the pressure equalizing valve such that the pressure difference downstream of the pressure equalizing valve is equalized. The effective flow cross-section of the cold water duct is the smallest flow cross-section along the cold water duct. The effective flow cross-section of the hot water duct is the smallest flow cross-section along the hot water duct.

Preferably, the pressure equalizing valve comprises a cold water inlet, a hot water inlet, a cold water outlet, a hot water outlet and a displaceable piston, wherein the piston is arranged between the cold water inlet and the hot water inlet and between the cold water outlet and the hot water outlet, so that the piston fluidically separates the cold water flowing through the pressure equalizing valve and the hot water flowing through the pressure equalizing valve. In particular, the piston is designed in such a manner that it moves according to the pressure conditions at the cold water inlet and the hot water inlet. The pressure conditions at the cold water inlet and at the hot water inlet cause an axial displacement of the piston along the longitudinal axis of the pressure equalizing valve, namely in such a manner that a balance of forces is established at the piston.

The piston is preferably designed in such a manner that the displacement of the piston increases or decreases the respective flow cross-section of the cold water and hot water flowing through the pressure equalizing valve-depending on the prevailing pressure conditions. Specifically, the piston can be designed in such a manner that, if the pressure in the cold water supply line is greater than the pressure in the hot water supply line, the piston moves in the direction of the hot water duct, thereby reducing the flow cross-section of the cold water flowing through the pressure equalizing valve and simultaneously increasing the flow cross-section of the hot water flowing through the pressure equalizing valve. A piston designed in this manner can also be designed such that, if the pressure in the hot water supply line is greater than the pressure in the cold water supply line, the piston is displaced in the direction of the cold water duct, thereby reducing the flow cross-section of the hot water flowing through the pressure equalizing valve and simultaneously increasing the flow cross-section of the cold water flowing through the pressure equalizing valve.

The pressure equalizing valve is in particular configured in such a manner that the piston completely closes the cold water inlet in a first end position and simultaneously completely opens the hot water inlet, that the piston partially closes the cold water inlet in any number of intermediate positions and simultaneously also partially closes the hot water inlet, wherein it applies that the more the piston closes the cold water inlet, the less the piston simultaneously closes the hot water inlet, and vice versa, and that the piston completely opens the cold water inlet in a second end position and simultaneously completely closes the hot water inlet.

By automatically changing or adapting the flow cross-section of the cold and hot water flowing through the pressure equalizing valve, the pressure equalizing valve equalizes the described pressure difference downstream of the pressure equalizing valve. This in turn means that temperature-controlled mixed water can be produced independently of any pressure differences in the supply lines of the device, namely using comparatively simple means.

Another positive effect of the pressure equalizing valve on the device according to the invention is that, in the event of a pressure difference between the cold water supply line and the hot water supply line, the cold water actuator or the hot water actuator-depending on whether the pressure in the cold water supply line exceeds the pressure in the hot water supply line or vice versa-the cold water diaphragm valve or the hot water diaphragm valve have to deflect less in order to achieve the desired mixed water ratio or the desired mixed water temperature. On the one hand, this is gentle on the corresponding diaphragm valves and, on the other hand, it saves energy for the corresponding actuators. In addition, this prevents a phenomenon known as chattering, whereby a pressurized diaphragm valve opens and closes uncontrollably.

According to an advantageous embodiment, the cold water actuator is a linear stepper motor. This is a motor configured to axially displace a drive shaft. Depending on the displacement of the shaft driven in this manner, a water duct of the cold water diaphragm valve opens or closes. By means of linear stepper motor, the cold water diaphragm valve can be precisely controlled or actuated, that is, opened and closed.

According to another advantageous embodiment, the hot water actuator is a linear stepper motor. This is a motor configured to axially displace an input shaft. Depending on the displacement of the shaft driven in this manner, a water duct of the hot water diaphragm valve opens or closes. By means of the linear stepper motor, the hot water diaphragm valve can be precisely controlled or actuated, that is, opened and closed.

According to another advantageous embodiment, the device according to the invention comprises a temperature sensor arranged in the mixed water duct for detecting the temperature of the mixed water. By detecting the mixed water temperature, this information can be made usable in a closed control loop. In addition, the information of the mixed water temperature can be supplied to a monitoring or quality control system. For example, this can be used to detect any technical defects at an early stage.

According to another advantageous embodiment, the device according to the invention comprises a battery for supplying the cold water actuator and the hot water actuator with electrical energy. The cold water actuator and the hot water actuator are electrical machines that require electrical energy for their respective operation. The construction and mode of operation of the device according to the invention allow the actuators to work in an energy-saving manner, in particular because, in the event of the described pressure difference, the pressure equalizing valve requires smaller deflections of the respective diaphragm valves to produce the desired temperature-controlled mixed water. As a result, comparatively low-power actuators can be used in the device according to the invention. This in turn makes it possible at all to dispense with a wired power supply to the device according to the invention and to provide a battery instead. The use of a battery in turn allows a particularly versatile use of the device according to the invention.

Alternatively, according to another advantageous embodiment, the device according to the invention comprises a rechargeable battery for supplying the cold water actuator and the hot water actuator with electrical energy. Again, it applies here that the cold water actuator and the hot water actuator are electrical machines that require electrical energy for operation. The construction and mode of operation of the device according to the invention allow for an energy-saving mode of operation of the actuators, in particular because, in the event of the described pressure difference, the pressure equalizing valve requires smaller deflections of the respective diaphragm valves to produce the desired temperature-controlled mixed water. As a result, comparatively low-powered actuators can be used in the device according to the invention. This in turn makes it possible at all to dispense with a wired power supply to the device according to the invention and to provide a rechargeable battery instead. The use of a rechargeable battery in turn allows for a particularly versatile use of the device according to the invention. Furthermore, the use of a rechargeable battery is comparatively environmentally friendly because it is rechargeable.

The present invention will be explained in more detail below based on the figure. In the figure, an advantageous embodiment of the invention is shown, but the invention is not limited to this advantageous embodiment. The same components are always provided with the same reference signs in the figures and are therefore generally only named or mentioned once. In the figure, in detail,

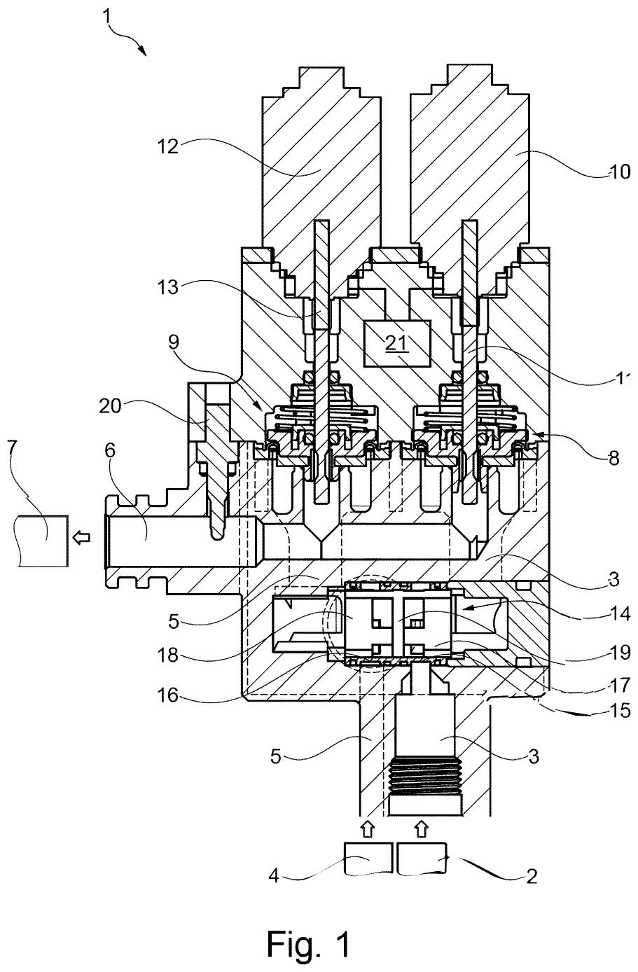

FIG. 1 shows an embodiment of the device according to the invention in a schematic, semi-transparent side view.

The single FIGURE shows an embodiment of the device 1 according to invention for producing temperature-controlled mixed water.

The device 1 comprises a cold water duct 3 connectable to a cold water supply line 2, a hot water duct 5 connectable to a hot water supply line 4, and a mixed water duct 6 into which the cold water duct 3 and the hot water duct 5 each open. The mixed water duct 6 is connectable to a continuing water pipe 7.

Furthermore, the device 1 comprises a cold water diaphragm valve 8 arranged in the cold water duct 3 for limiting the cold water quantity flowing through the cold water duct 3 or into the mixed water duct 6. In addition, the device 1 comprises a hot water diaphragm valve 9 arranged in the hot water duct 5 for limiting the hot water quantity flowing through the hot water duct 5 or into the mixed water duct 6. The device 1 also comprises a cold water actuator 10 in the form of a linear stepper motor for actuating the cold water diaphragm valve 8 by means of an axially displaceable drive shaft 11, and a hot water actuator 12 in the form of a linear stepper motor for actuating the hot water diaphragm valve 9 by means of an axially displaceable drive shaft 13.

Finally, the device 1 comprises a pressure equalizing valve 14, which is arranged upstream of the cold water diaphragm valve 8 in the cold water duct 3 and upstream of the hot water diaphragm valve 9 in the hot water duct 5. The pressure equalizing valve 14 is designed such that in the event of a pressure difference between the cold water supply line 2 and the hot water supply line 4, it automatically changes the flow cross-section of the cold water flowing through the pressure equalizing valve 14 and, at the same time, changes the flow cross-section of the hot water flowing through the pressure equalizing valve 14.

The pressure equalizing valve 14 has a hollow cylindrical base body open on both sides. It comprises a cold water inlet 15 and a hot water inlet 16, each of which is formed as an opening in the outer surface of the base body of the pressure equalizing valve 14. Furthermore, the pressure equalizing valve 14 comprises a cold water outlet 17 and a hot water outlet 18, which are each formed by the open end sides of the base body of the pressure equalizing valve 14. The cold water inlet 15 and the cold water outlet 17 of the pressure equalizing valve 14 together form part of the cold water duct 3. The hot water inlet 16 and the hot water outlet 18 of the pressure equalizing valve 14 together form part of the hot water duct 5. Furthermore, the pressure equalizing valve 14 comprises a piston 19 that can be displaced along the longitudinal axis of the pressure equalizing valve 14, wherein the piston 19 is arranged between the cold water inlet 15 and the hot water inlet 16 and between the cold water outlet 17 and the hot water outlet 18.

To detect the temperature of the mixed water, the device 1 also comprises a temperature sensor 20, the probe of which extends into the mixed water duct 6.

Furthermore, the device 1 comprises a rechargeable battery 21 for supplying the cold water actuator 10 and the hot water actuator 12 with electrical energy.

### REFERENCE LIST

1 device for producing temperature-controlled mixed water
2 cold water supply line
3 cold water duct
4 hot water supply pipe
5 hot water duct
6 mixed water duct
7 continuing water pipe
8 cold water diaphragm valve
9 hot water diaphragm valve
10 cold water actuator
11 drive shaft of the cold water actuator
12 hot water actuator
13 drive shaft of the hot water actuator
14 pressure equalizing valve
15 cold water inlet
16 hot water inlet
17 cold water outlet
18 hot water outlet
19 piston
20 temperature sensor
21 rechargeable battery

1. A device (1) for producing temperature-controlled mixed water, comprising
a cold water duct (3) connectable to a cold water supply line (2),
a hot water duct (5) connectable to a hot water supply line (4),
a mixed water duct (6) into which the cold water duct (3) and the hot water duct (5) each open,
a cold water diaphragm valve (8) arranged in the cold water duct (3) for limiting a quantity of cold water flowing through the cold water duct (3),
a hot water diaphragm valve (9) arranged in the hot water duct (5) for limiting a quantity of hot water flowing through the hot water duct (5),
a cold water actuator (10) for actuating the cold water diaphragm valve (8),
a hot water actuator (12) for actuating the hot water diaphragm valve (9), and
a pressure equalizing valve (14) arranged upstream of the cold water diaphragm valve (8) in the cold water duct (3) and upstream of the hot water diaphragm valve (9) in the hot water duct (5),
wherein
the pressure equalizing valve (14) is configured so that, in the event of a pressure difference between the cold water supply line (2) and the hot water supply line (4), said pressure equalizing valve automatically changes the flow cross-section of the cold water flowing through the pressure equalizing valve (14) and, at the same time, changes the flow cross-section of the hot water flowing through the pressure equalizing valve (14) such that the pressure difference is equalized downstream of the pressure equalizing valve (14).

2. The device according to claim 1, wherein the cold water actuator (10) is a linear stepper motor.

3. The device according to claim 1, wherein the hot water actuator (12) is a linear stepper motor.

4. The device according to claim 1, comprising a temperature sensor (20) arranged in the mixed water duct (6) for detecting a mixed water temperature.

5. The device according to claim 1, comprising a battery for supplying the cold water actuator (10) and the hot water actuator (12) with electrical energy.

6. The device according to claim 1, comprising a rechargeable battery (21) for supplying the cold water actuator (10) and the hot water actuator (12) with electrical energy.

7. The device according to claim 2, wherein the hot water actuator (12) is a linear stepper motor.

8. The device according to claim 2, comprising a temperature sensor (20) arranged in the mixed water duct (6) for detecting ta mixed water temperature.

9. The device according to claim 3, comprising a temperature sensor (20) arranged in the mixed water duct (6) for detecting a mixed water temperature.

10. The device according to claim 2, comprising a battery for supplying the cold water actuator (10) and the hot water actuator (12) with electrical energy.

11. The device according to claim 3, comprising a battery for supplying the cold water actuator (10) and the hot water actuator (12) with electrical energy.

12. The device according to claim 4, comprising a battery for supplying the cold water actuator (10) and the hot water actuator (12) with electrical energy.

13. The device according to claim 2, comprising a rechargeable battery (21) for supplying the cold water actuator (10) and the hot water actuator (12) with electrical energy.

14. The device according to claim 3, comprising a rechargeable battery (21) for supplying the cold water actuator (10) and the hot water actuator (12) with electrical energy.

15. The device according to claim 4, comprising a rechargeable battery (21) for supplying the cold water actuator (10) and the hot water actuator (12) with electrical energy.
